(19) United States
(12) Patent Application Publication
(10) Pub. No.: US 2009/0090550 A1
(43) Pub. Date: Apr. 9, 2009

(54) CABLE MANAGEMENT APPARATUS

(75) Inventor: John R. Bird, Newton, NH (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 11/869,385

(22) Filed: Oct. 9, 2007

(51) Int. Cl. H02B 1/20; H02B 1/015

(52) U.S. Cl. 174/500

(57) ABSTRACT

A cable management apparatus for housing and organizing cables includes a stationary member having a set of ribs bridged by at least one spine and forming a first side wall, a second side wall, and a bottom wall. Further, the cable management apparatus also includes a first movable member having a set of ribs bridged by at least one spine, such that, the first movable member is movable toward at least the first or the second side wall. A method for managing cables includes providing a stationary member having a plurality of ribs bridged by at least one spine and forming a first side wall, a second side wall, and a bottom wall. Further, the method for managing cables also includes, providing a first movable member having a plurality of ribs bridged by at least one spine, such that, the first movable member is movable toward at least the first or the second side wall.

### BACKGROUND OF INVENTION

FIG. 1 shows a typical set of server racks 10. Computer systems and other rack-mounted electronics receive input and send output through channels to communicate information with other electronic components. Typically, these channels take the form of a variety of different communication cables having a connector at each free end for engaging inputs and outputs on respective electronic components. Communication cables such as Ethernet, infiniband, Fiber Channel, PCI Express, and Serial ATA, or the like, connect various types of electronic components such as computer servers, storage devices, personal computers, etc. These communication cables generally transfer power or input and output signals between the respective electronic components.

In many of the described cables, the maximum radius of curvature is well defined, and bending the cable past its threshold bending level may cause damage to the communication medium that is housed within the communication cable. For example, Ethernet cables are relatively resilient and include a rather high radius of curvature. In contrast, communication cables such as infiniband, which provide faster rates of communication than Ethernet, have a lower maximum bend radius and, thus, are relatively fragile. Provided that an infiniband cable is only bent at a radius less than or equal to its maximum bend radius, signal transmission quality of the infiniband will not be reduced. The greater the infiniband cable is bent past its maximum bend radius, the greater the potential for breaking, e.g., the fibers, contained in the communication cable, and the shorter the life span of the cable.

As a result, infiniband cables are not typically “shipped” or “transported” while actually connected to respective electronic components. Instead, the infiniband cables and their respective devices are shipped “disconnected” and then connected at the final end user site. For example, attempting to ship infiniband cables while connected to their respective electronic components typically results in the electronic components suffering failures from broken connector leads, etc. Specifically, the fragile nature of infiniband cables is easily vulnerable to dynamic shock and vibration forces during transport. In particular, the shock and the forces are transferred to the communication cables, which are too fragile to survive such transport.

Furthermore, areas that include densely packed electronic components results in densely packed communication cables. Thus, while being densely packed, communication cables have to be routed over surfaces without over bending the cable past its maximum bend radius, yet also, the communication cable must be secured in a manner to ensure protection from damage. For example, infiniband cables may be subject to failure during and after installation due to the mass of weight of other cable bundles in a rack. It is not unusual for many tens of pounds of cables, e.g., Ethernet and system management cables, to be run in close proximity to the much more fragile infiniband cables. For example, during routine maintenance the non-infiniband cables may be moved around subjecting the infiniband cable connections to severe loads causing failures.

Thus, it is desirable to keep infiniband cables separate from other cable bundles. However, the maximum bend radius resulting from the stiffness of infiniband cables makes it difficult to route these cables out of the way. One solution for keeping cables separated is through the use of one or more hooks and loop closures onto which the communication cables are placed to create a cable chase. Such cable chases are employed to accommodating different sizes and types of cables without causing strain and negatively affecting the cables, electronic components, or data transmission.

### SUMMARY OF THE INVENTION

In one or more embodiments of the present invention, a cable management apparatus for housing and organizing cables comprises, a stationary member comprising a plurality of ribs bridged by at least one spine and forming a first side wall, a second side wall, and a bottom wall, a first movable member comprising a plurality of ribs bridged by at least one spine, wherein the first movable member is movable toward at least the first or the second side wall.

In one or more embodiments of the present invention, a method for managing cables comprises, providing a stationary member comprising a plurality of ribs bridged by at least one spine and forming a first side wall, a second side wall, and a bottom wall, providing a first movable member comprising a plurality of ribs bridged by at least one spine, wherein the first movable member is movable toward at least the first or the second side wall.

### BRIEF DESCRIPTION OF DRAWINGS

FIG. 1 shows a typical set of server racks.

FIG. 2 shows a perspective view of a cable management apparatus in accordance with one or more embodiments of the present invention.

FIG. 3 shows a perspective view of a movable member in accordance with one or more embodiments of the present invention.

FIG. 4 shows a front view of a cable management apparatus in accordance with one or more embodiments of the present invention.

FIG. 5 shows a perspective view of a cable management apparatus managing a variety of different cables in accordance with one or more embodiments of the present invention.

FIG. 6 shows a end view of a cable management apparatus in accordance with one or more embodiments of the present invention.

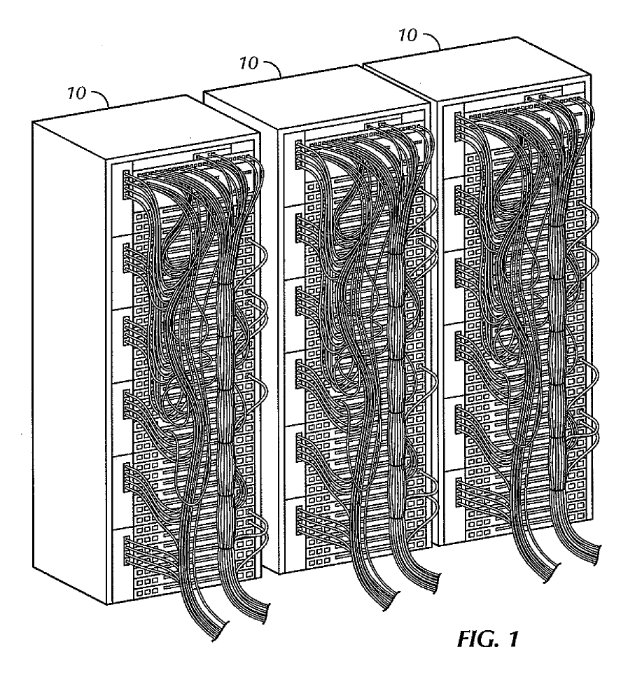

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a cable management apparatus, and more particularly cable management apparatus for use with communication cables. More specifically, embodiments of the invention provide a cable manager including a stationary member and a movable member, such that the movable member may be pivotally attached to the stationary member to narrow or widen cable storage areas.

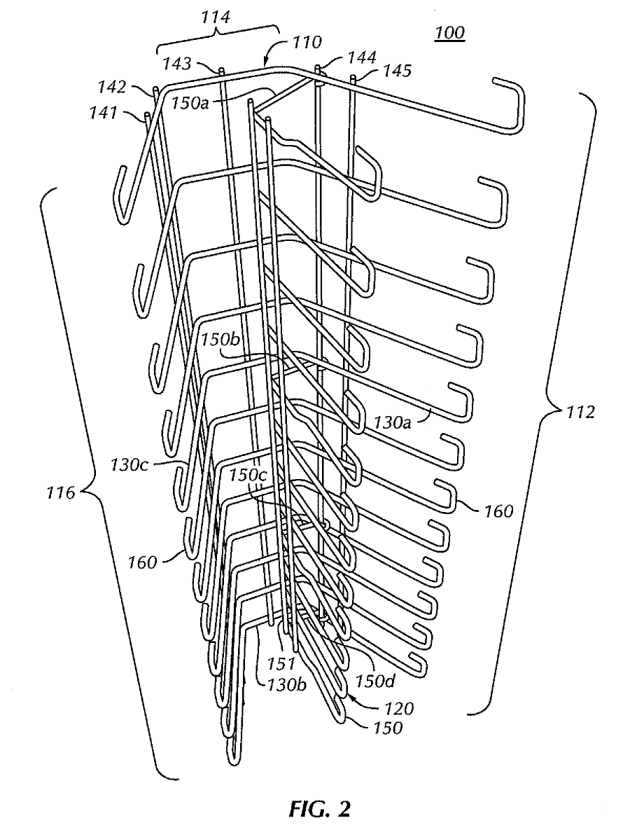

FIG. 2 shows a perspective view of a cable management apparatus 100 in accordance with one or more embodiments of the present invention. The cable management apparatus includes a stationary member 110 and a movable member 120. In one or more embodiments of the present invention, the cable management apparatus 100 may be formed from, e.g., wire form fabric, sheet metal, extruded molded plastic, injection molded plastic, or the like, formed into a plurality of ribs and spines. Specifically, the stationary member 110 includes a set of ribs 130 which form a bottom wall 114, a first side wall 112, and a second side wall 116. In particular, the bottom wall 114 is formed of a portion 130b of ribs 130. The rib portions 130b are disposed horizontally and may be equidistant with respect to each other. The rib portions 130b are bridged centrally and perpendicularly by a spine 143 that extends across the entire bottom wall 114.

Still referring to FIG. 2, the first side wall 112 and the second side wall 116 are formed from rib portions 130a and 130c, respectively. Specifically, the rib portions 130a and 130c are extensions of rib portions 130b, such that the set of ribs 130 are divided into rib portions 130a, 130b, and 130c. The rib portions 130a and 130c are bent upwards from the bottom wall 114 as extensions of the rib portions 130b, such that the set of ribs 130 are bent in two places to form the first side wall 112 and the second side wall 116. As shown, the first side wall 112 and the second side wall 116 are each disposed at an angle, e.g., 60 degrees, to the bottom wall 114. However, one of ordinary skill in the art will appreciate that the first and second walls 112, 116 may be positioned at any angle with respect to the bottom wall 114 without departing from the scope of the present invention. For example, the side walls 112, 116 could be positioned at a 45 degree angle to the bottom wall 114, or the first side wall 112 could be positioned at a 30 degree angle while the second side wall 116 could be positioned at a 60 degree angle to the bottom wall 114. One of ordinary skill in the art will appreciate that the combination of ribs and spines disposed at certain angles to form the cable management apparatus 100 may dampen the dynamic loads normally transferred to the cables during, e.g., shipping or transport.

In addition, although FIG. 2 shows the first side wall 112, the second side wall 116, and the bottom wall 114 using one set of ribs 130 bent upwards in two different places, one of ordinary skill in the art will appreciate that the first side wall 112, the second side wall 116, and the bottom wall 114 may be separately formed. For example, instead of the first and second side walls 112, 116 being formed from upwardly bent portions of the bottom walls rib portions 130b, the first and second side walls 112, 116 may be formed from separate sets of ribs that are attached to either ends of the ribs 130b at an upwards angle through, e.g., welding or gluing.

Similar to the configuration of the bottom wall 114, the first side wall 112 is bridged by two spines 144, 145 that extend perpendicularly across the entire first side wall 112. Similarly, the second side wall 116 is bridged by two spines 141, 142 that extend perpendicularly across the entire second side wall 116. One of ordinary skill in the art will appreciate that the ribs 130a-130c may be attached to their respective spines 141-145 by any means known in the art, for example, gluing or welding.

In one or more embodiments of the present invention, the set of ribs 130 may be spaced 1.75″ or one “rack-unit” apart. However, while an equally spaced set of thirteen ribs 130 are shown in FIG. 2, one of ordinary skill in the art will appreciate that any number of ribs, spines, and configuration of ribs and spines may be used without departing from the scope of the present invention. For example, the spine 143 may only extend across a portion of the bottom wall 114, or the bottom wall 114 may include additional spines. Specifically, in one or more embodiments of the present invention, if the bottom wall is significantly wider because of lengthier ribs, more than one spine may be required to provide proper support and balance for the stationary member 110. Further, in one or more embodiments of the present invention, when larger cables are not being used, it may be desirable to include more ribs disposed closer together throughout the stationary member 110 to facilitate management of thinner cables such as Ethernet cables.

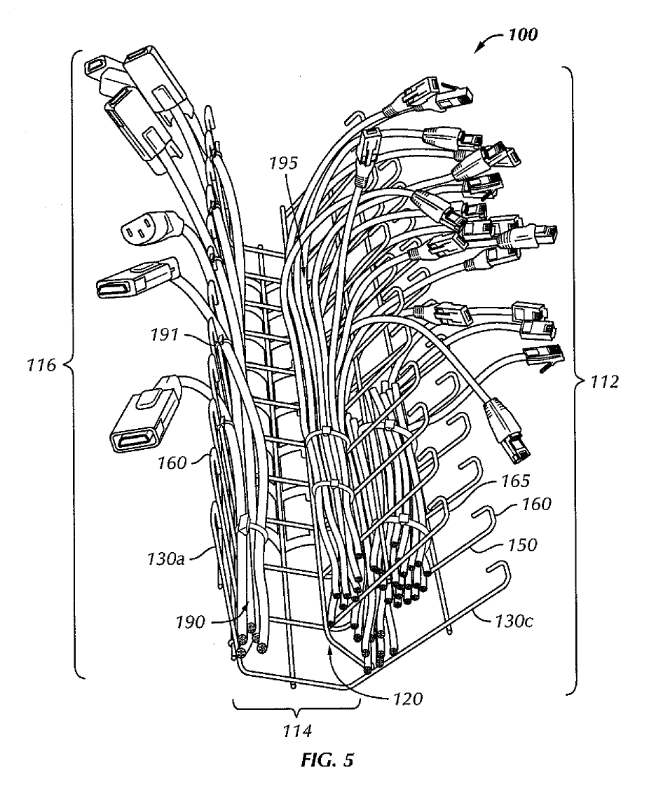

Still referring to FIG. 2, each of the free ends of the rib portions 130a, 130c include a hook formation 160. When communication cables are attached at different points throughout the cable management apparatus 100, the hook formations 160 will prevent the cables from moving or contacting each other. One of ordinary skill in the art will appreciate that while hook formations 160 are shown in FIG. 2, the present invention is not limited to hook formations 160. For example, the ends of the rib portions 130a, 130c could include “T” formations without departing from the scope of the invention to prevent the cables from moving or contacting each other. The function of the hook formations 160 will be shown in more detail in the description for FIG. 5.

In addition to the stationary member 110, the cable management apparatus 100 includes the movable member 120 for facilitating various sizes of cables; in particular, the movable member 120 may provide effective support and security for infiniband cables during transport and storage. FIG. 3 shows a perspective view of the movable member 120 shown in FIG. 2. Thus, referring now to FIGS. 2 and 3, the movable member 120 is pivotal about spine 144 on the first side wall 112, such that when the movable member 120 is pivoted toward the first side wall 112, the area between the first side wall 112 and the movable member 120 decreases as the area between the second side wall 116 and the movable member 120 increases. Increasing the area between the movable member 120 and the second side wall 116 provides more space for housing, e.g., infiniband cables while keeping thinner cables, e.g., Ethernet cables, housed in the narrower area between the first side wall 112 and the movable member 120. Similarly, when the movable member 120 is pivoted toward the second side wall 116, the area between the second side wall 116 and the movable member 120 decreases as the area between the first side wall 112 and the movable member 120 increases. The ability to increase and decrease areas in the cable management apparatus 100 may be able to house a different variety of cable sizes as shown in the description for FIG. 5.

As shown in FIGS. 2 and 3, the movable member 120 is formed of a set of ribs 150. While the height of the movable member 120 appears to be substantially equal to the height of the first and second side walls 112, 116, one of ordinary skill in the art will appreciate that the ribs 150 of the movable member 120 may be any length without departing from the scope of the invention. For example, ribs 150 on the movable member 120 may alternate between short and tall ribs 150. Further, the ribs 150 on the movable member 120 are bridged by a spine 151, such that the spine 151 extends across the entire movable member 120. As shown, the spine 151 is disposed perpendicular to the ribs 150.

Further, one or more ribs 150 include rib portions 150a-150d which extend upwards at an angle past the spine 151. As shown, the rib portions 150a-150d extend toward the spine 144 on the first side wall 112, such that the extended portions 150a-150d are used by the movable member 120 to pivot about spine 144. Specifically, the rib portions 150a-150d attach to the spine 144, thereby enabling the movable member 120 to pivot toward the first side wall 112 and the second side wall 116. Each of the extending ribs 150a-150d include a hook 170 for securing the movable member 120 to the spine 144 of the first side wall 112. Each hook 170 is tightly wrapped around the spine 144 so as not to allow transverse movement along the spine 144 of the movable member 120, only pivotal movement. Alternatively, in one or more embodiments of the present invention, the movable member 120 may be fixed to the spine 144, such that the spine 144 itself may be rotatable enabling the movable member to pivot toward the first side wall 112 and the second side wall 116. Those of ordinary skill in the art will appreciate that the method used by the movable member 120 to pivot toward the first side wall 112 and the second side wall 116 may be any means known in the art and is not limited to hooks 170 or a rotatable spine 144.

Each of the free ends of the ribs 150 include hook formations 165. When cables are attached at different points throughout the cable management apparatus 100, the hook formations 165 will prevent the cables from moving or contacting each other. One of ordinary skill in the art will appreciate that while hook formations 165 are shown in FIGS. 2 and 3, the present invention is not limited to hook formations 160. For example, the ends of the rib portions 130a, 130c could include “T” formations without departing from the scope of the invention to prevent the cables from moving or contacting each other. The function of the hook formations 165 will be shown in more detail in the description for FIG. 5.

While only one movable member 120 is shown in FIG. 2, those of ordinary skill in the art will appreciate that the present invention is not limited to one movable member 120, but may include multiple movable members to support and manage a variety of different types and sizes of cables as will be shown in the description for FIG. 6. Thus, those of ordinary skill in the art will appreciate that a number of combinations of sizes and numbers of movable members may be used in conjunction with the stationary member 110 to facilitate a number of different sizes and shapes of cables.

Similar to the stationary member 110, in one or more embodiments of the present invention, the set of ribs 150 may be spaced 1.75″ or one “rack-unit” apart. However, while the movable member 120 includes a set of equally spaced thirteen ribs 150 and one spine 151 in FIGS. 2 and 3, one of ordinary skill in the art will appreciate that any number of ribs, spines, and configuration of ribs and spines may be used without departing from the scope of the present invention. For example, the movable member 120 may in fact be longer or shorter than the stationary member 110, requiring additional or fewer ribs 150, respectively. In one or more embodiments of the present invention, when larger cables are not being used, it may be desirable to include more ribs disposed closer together throughout the stationary member 110 to facilitate management of thinner cables such as Ethernet cables.

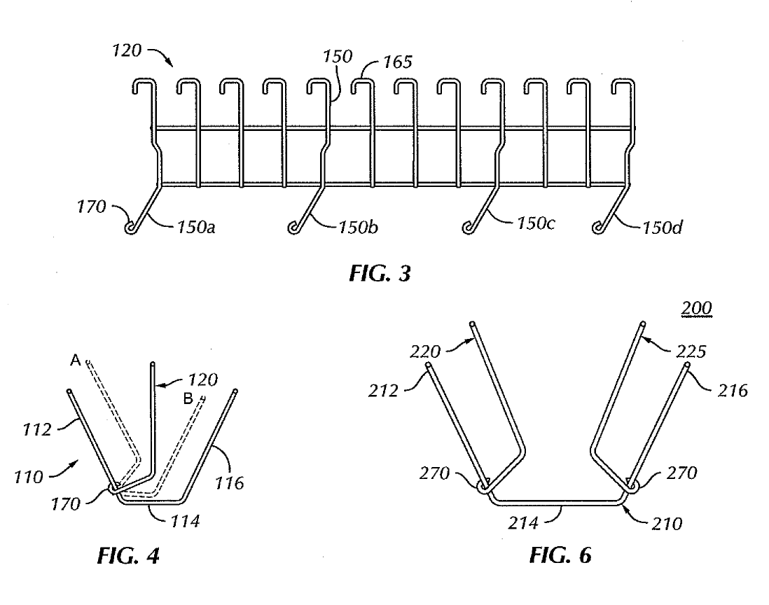

FIG. 4 shows a front view of the cable management apparatus 100 shown in FIG. 2. As discussed previously, the cable management apparatus 100 includes the stationary member 110 and the movable member 112. The stationary member 110 includes the first side wall 112, the second side wall 116, and the bottom wall 114. The first side wall 112 and the second side wall 116 are disposed at an angle, e.g., 60 degrees, to the bottom wall 114. However, one of ordinary skill in the art will appreciate that the first and second walls 112, 116 may be positioned at any angle with respect to the bottom wall 114 without departing from the scope of the present invention. For example, the side walls 112, 116 could be positioned at a 45 degree angle to the bottom wall 114, or the first side wall 112 could be positioned at a 30 degree angle while the second side wall 116 could be positioned at a 60 degree angle to the bottom wall 114.

The movable member 120 is pivotal about a spine (not shown) on the first side wall 112, such that when the movable member 120 is pivoted toward the first side wall 112, e.g., in position a, the area between the first side wall 112 and the movable member 120 decreases as the area between the second side wall 116 and the movable member 120 increases. Increasing the area between the movable member 120 and the second side wall 116, i.e., placing the movable member 120 in position a, provides more space for housing, e.g., infiniband cables while keeping more thinner cables, e.g., Ethernet cables, housed in the narrower area between the first side wall 112 and the movable member 120. Similarly, when the movable member 120 is pivoted toward the second side wall 116 into position b, the area between the second side wall 116 and the movable member 120 decreases as the area between the first side wall 112 and the movable member 120 increases. The ability to increase and decrease areas in the cable management apparatus 100 may be able to house a different variety of cable sizes as shown in the description for FIG. 5.

The movable member 120 includes hooks 170 for securing the movable member 120 to the spine of the first side wall 112. The hook 170 is tightly wrapped around the spine so as not to allow transverse movement along the spine of the movable member 120, only pivotal movement. Alternatively, in one or more embodiments of the present invention, the movable member 120 may be fixed to the spine, such that the spine itself may be rotatable enabling the movable member to pivot toward the first side wall 112 and the second side wall 116. Those of ordinary skill in the art will appreciate that the method used by the movable member 120 to pivot toward the first side wall 112 and the second side wall 116 may be any means known in the art and is not limited to hooks 170 or a rotatable spine.

While only one movable member 120 is shown in FIG. 4, those of ordinary skill in the art will appreciate that the present invention is not limited to one movable member 120, but may include multiple movable members to support and manage a variety of different types and sizes of cables as will be shown in the description for FIG. 6. Thus, those of ordinary skill in the art will appreciate that a number of combinations of sizes and numbers of movable members may be used in conjunction with the stationary member 110 to facilitate a number of different sizes and shapes of cables.

FIG. 5 shows a perspective view of the cable management apparatus 100 as shown in FIG. 2 housing a variety of cables 190 and 195 in accordance with one or more embodiments of the present invention. As shown, the movable member 120 has been pivoted toward the first side wall 112 allowing space for numerous cables 190 to be secured to the second side wall 116. For example, the cables 190 may be infiniband cables which are relatively fragile and have a low maximum bend radius. Further, because the cables 190 are especially thick, a wider area is needed to store the cables without breaking them because of too compact an area. Thus, in order to transport infiniband cables while connected or disconnected to their respective infiniband devices, adequate space is required to prevent breakage of the fragile cables. In addition, the narrow space created between the first side wall 112 and the movable member 120 may be used to house thinner cables 195. For example, thinner, resilient cables such as Ethernet cables may be housed separately from the cables 190 while still in close proximity.

As shown in FIG. 5, multiple ties 191 are used to secure the cables 190 and 195 to the cable management apparatus 100 in different locations. However, one of ordinary skill in the art will appreciate that the cables 190 and 195 may be secured to the cable management apparatus 100 by any means known in the art and is not limited to ties 191, for example, clasps, Velcro, snaps, or the like.

As discussed previously, each of the free ends of the rib portions 130a, 130c of ribs 150 include hook formations 160 and 165, respectively. When cables 190 and 195 are attached at different points throughout the cable management apparatus 100, the hook formations 160 and 165 will prevent the cables 190 and 195 from moving or contacting each other. One of ordinary skill in the art will appreciate that while hook formations 160 and 165 are shown in FIG. 5, the present invention is not limited to hook formations 160 and 165. For example, the ends of the rib portions 130a, 130c and ribs 150 could include “T” formations without departing from the scope of the invention to prevent the cables from moving or contacting each other.

Referring now to FIG. 6, a front view of a cable management apparatus 200 is shown in accordance with one or more embodiments of the present invention. Similar to the embodiment shown in FIG. 2, the cable management apparatus 200 includes a stationary member 210 and a first movable member 220. In contrast to the embodiment shown in FIG. 2, the cable management apparatus 200 includes a second movable member 225, thus making it possible to create three different areas to separate the cables.

The stationary member 210 includes a plurality of ribs (not shown) which form a bottom wall 214, a first side wall 212, and a second side wall 216. The first side wall 212 and the second side wall 216 are each disposed at an angle, e.g., 60 degrees, to the bottom wall 214. However, one of ordinary skill in the art will appreciate that the first and second walls 212, 216 may be positioned at any angle with respect to the bottom wall 214 without departing from the scope of the present invention. For example, the side walls 212, 216 could be positioned at a 45 degree angle to the bottom wall 214, or the first side wall 212 could be positioned at a 30 degree angle while the second side wall 216 could be positioned at a 60 degree angle to the bottom wall 214.

The first and second movable members 220, 225 are pivotal about a spine (not shown) on the first side wall 212 and second side wall 216, respectively, such that when the first movable member 220 is pivoted toward the first side wall 212, the area between the first side wall 212 and the first movable member 220 decreases as the area between the second movable member 225 and the first movable member 220 increases. Similarly, when the second movable member 225 is pivoted toward the second side wall 216, the area between the second side wall 216 and the second movable member 225 decreases as the area between the first moveable member 220 and the second movable member 225 increases. The ability to increase and decrease areas in the cable management apparatus 200 may be able to support different shapes and sizes of cables.

Each of the first and second movable members 220, 225 include hooks 270 for securing the first and second movable members 220, 225 to the first side wall 212 and the second side wall 216, respectively. The hooks 270 are tightly wrapped around the spines (not shown) on the first side wall 212 and the second side wall 216 so as not to allow transverse movement along each spine, only pivotal movement. Alternatively, in one or more embodiments of the present invention, the first and second movable members 220, 225 may be fixed to the spines on the first side wall 212 and the second side wall 216, such that the spines themselves may be rotatable enabling the first and second movable members 220, 225 to pivot toward the first side wall 212 and the second side wall 216.

While only two movable members 220, 225 are shown in FIG. 6, those of ordinary skill in the art will appreciate that the present invention is not limited to two movable members 220, 225 but may include multiple movable members to support and manage a variety of different types and sizes of cables. Thus, those of ordinary skill in the art will appreciate that a number of combinations of sizes and a number of movable members may be used in conjunction with the stationary member 210 to facilitate a number of different sizes and shapes of cables. Further, those of ordinary skill in the art will appreciate that the combination of ribs and spines disposed at certain angles to form the cable management apparatus 200 may dampen the dynamic loads normally transferred to the cables during, e.g., shipping or transport.

One or more embodiments of the present invention may include one or more of the following advantages. A cable management apparatus that provides substantially unimpeded electronic device access, substantially unrestricted cable movement/attachment, and substantially unrestricted air flow into and out of an electronic device that may be attached to the cables housed in the cable management apparatus. Further, one or more embodiments of the present invention provides for a reliable way to attach and support fragile cables, e.g., infiniband cables, up close to a computer server. In addition, the design of one or more embodiments of the cable management apparatus may be lightweight, economically efficient, aesthetically pleasing, rugged, capable of supporting many pounds of cable vertically, and restrain cables horizontally. Serviceability of the rack system is increased because of the ability to move the cables on the cable management apparatus while still connected, i.e., access to the electronic devices can be gained without requiring disconnection of the cables.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A cable management apparatus for housing and organizing cables comprising:
a stationary member comprising a plurality of ribs bridged by at least one spine and forming a first side wall, a second side wall, and a bottom wall
a first movable member comprising a plurality of ribs bridged by at least one spine;
wherein the first movable member is movable toward at least the first or the second side wall.

2. The cable management apparatus according to claim 1, wherein the first movable member is attached to and rotatable around the at least one spine of the stationary member.

3. The cable management apparatus according to claim 1, further comprising a plurality of securing devices configured to secure the cables to the stationary member and the first movable member.

4. The cable management apparatus according to claim 1, wherein the first side wall and the second side wall are positioned at an angle with respect to the bottom wall.

5. The cable management apparatus according to claim 1, wherein the plurality of ribs of the stationary member comprises a restraining means for restraining the cables.

6. The cable management apparatus according to claim 1, wherein the plurality of ribs of the first movable member comprises a restraining means for restraining the cables.

7. The cable management apparatus according to claim 1, further comprising at least a second movable member comprising a plurality of ribs bridged by at least one spine.

8. The cable management apparatus according to claim 1, wherein the first movable member further comprises an attaching means for attaching to the stationary member.

9. The cable management apparatus according to claim 1, wherein the first movable member is movably attached to the at least one spine of the stationary member.

10. A method for managing cables comprising:
providing a stationary member comprising a plurality of ribs bridged by at least one spine and forming a first side wall, a second side wall, and a bottom wall;
providing a first movable member comprising a plurality of ribs bridged by at least one spine;
wherein the first movable member is movable toward at least the first or the second side wall.

11. The method according to claim 10, further comprising, providing an attachment for rotating the first movable member around the at least one spine of the stationary member.

12. The method according to claim 10, further comprising, providing a plurality of securing devices configured to secure the cables to the stationary member and the first movable member.

13. The method according to claim 10, further comprising, positioning the first side wall and the second side wall at an angle to the bottom wall.

14. The method according to claim 10, further comprising, providing a restraining means on the plurality of ribs of the stationary member for restraining the cables.

15. The method according to claim 10, further comprising, providing a restraining means on the plurality of ribs of the first movable member for restraining the cables.

16. The method according to claim 10, further comprising, providing at least a second movable member comprising a plurality of ribs bridged by at least one spine.

17. The cable management apparatus according to claim 10, wherein the first movable member is movably attached to the at least one spine of the stationary member.
